(19) United States
(12) Patent Application Publication
(10) Pub. No.: US 2002/0143886 A1
(43) Pub. Date: Oct. 3, 2002

(54) Peer distributed embedded web server system

(75) Inventor: Douglas M. Camens, Lancaster, PA (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/821,176

(22) Filed: Mar. 29, 2001

(51) Int. Cl. G06F 15/16

(52) U.S. Cl. 709/208; 709/203

(57) ABSTRACT

An embedded web server system for accessing and controlling a multiplicity of devices. The system has at least one master web server that is cognizant of, and communicates with, other “servant” servers. The user accesses the multiplicity of devices through the master, using an ordinary web browser.

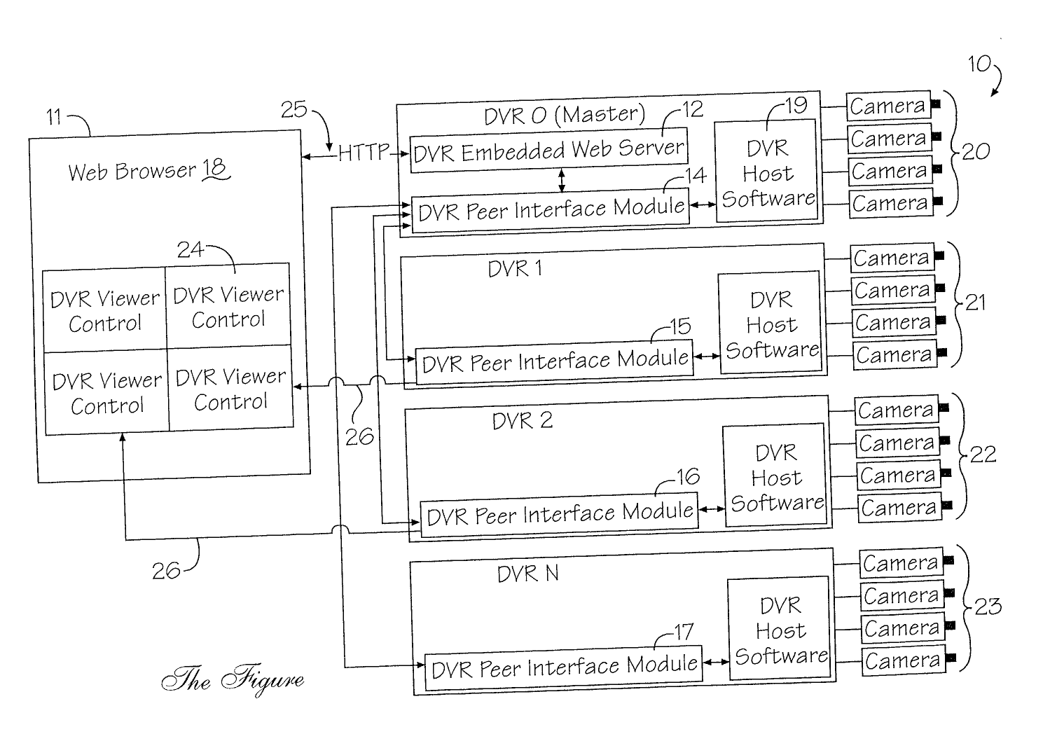

### FIELD OF THE INVENTION

The present invention relates to embedded web server (EWS) systems and, more particularly, to an embedded web server system that is used to access other devices, such as network cameras, network digital video encoders and network digital video recorders via a single, master embedded web server.

### BACKGROUND OF THE INVENTION

Embedded web servers allow a user of the Internet to configure and operate a single device using a standard web browser, such as Microsoft Internet Explorer® or Netscape Navigator®.

The peer distributed embedded web server system of this invention, however, is configured to extend the normal system to allow a user to access, via a single web browser, many devices of the same type, such as network digital video encoders or network cameras or DVRs. Each device comprises an on-board server that is not necessarily an EWS, but is one that handles the specifics of that device.

In this system the embedded web server allows a single browser based interface to control a multiplicity of devices without the need for inter-device communications using Hypertext Transport Protocol (HTTP). The peer-to-peer communications are abstracted by the embedded web server, and can be achieved by any protocol, such as TCP/IP.

The new configuration comprises a master device, such as a digital video recorder, that contains the EWS. This web server is a master that directs the web browser commands of the user to an appropriate peer device via a network. The user is not made aware that his summons can actually control a plurality of different devices in the network. The uniquely embedded master device communicates with other “servant” servers that are not true web servers (e.g., traditional socket servers). These socket servers are not necessarily cognizant of other devices in the system.

Sockets may also be used to communicate with the browser of the end user in the instance where a “relatively static” web page may not be sufficient (i.e., where the content of the web page changes only upon the request by the user to reload the page).

### DISCUSSION OF RELATED ART

In U.S. Pat. No. 6,006,265 issued to Ragan et al on Dec. 21, 1999 for HYPERLINKS RESOLUTION AT AND BY A SPECIAL NETWORK SERVER IN ORDER TO ENABLE DIVERSE SOPHISTICATED HYPERLINKING UPON A DIGITAL NETWORK, a system is shown having embedded hyperlinks that allows multiple users to access the same video camera. By contrast, the present invention features an embedded server that allows one user to access a multiplicity of digital video encoders, digital video recorders, or cameras.

### SUMMARY OF THE INVENTION

In accordance with the present invention, there is provided a peer distributed, embedded web server system for accessing and controlling a multiplicity of devices. The system comprises at least one master EWS that knows about, and communicates with, other “servant” servers. The user accesses the multiplicity of devices through the master, using an ordinary web browser. To the user, the only thing that is viewable is a customary web page. The web page contains data that is relevant to the multiplicity of devices. In the case of digital video recorders (DVRs), this data may include camera titles, quality levels, recent alarm events, diagnostics, etc. The user is aware that he can access or control the multiplicity of devices, but he is not cognizant that these devices are located elsewhere. The master EWS can be a digital video recorder (DVR) EWS that accepts the Hypertext Transport Protocol (HTTP) request from the web browser. A DVR viewer control can be loaded by the web browser in order to display live or recorded video from the DVRs. The user clicks on the hyperlink of the web page to view the video from one of the cameras. The request is sent to the master web server using a HTTP command. The master EWS responds by sending a web page containing instructions for the browser for receiving a video stream for a desired camera via the DVR viewer control. Additional DVRs can be added into the system easily by providing an administrative web page, wherein the user informs the master DVR web server of the address of a newly added DVR. This information would then be incorporated into the master DVR.

It is an object of this invention to provide an improved communication system featuring an embedded web server that controls and communicates with a plurality of devices via a web browser command.

### BRIEF DESCRIPTION OF THE DRAWINGS

A complete understanding of the present invention may be obtained by reference to the accompanying drawing, when considered in conjunction with the subsequent detailed description, in which:

The FIGURE illustrates a software component block diagram of the system of the invention.

### DESCRIPTION OF THE PREFERRED EMBODIMENT

Generally speaking, the invention features a peer distributed, embedded web server system for accessing and controlling a multiplicity of devices. The system comprises at least one master web server that knows about, and communicates with, other servant servers. The user accesses the multiplicity of devices (digital video recorders, digital video encoders, cameras) through the master, using an ordinary web browser.

Now referring to the FIGURE, an embedded web server system 10 is illustrated. The system comprises a plurality of devices, such as digital video recorders DVR₀, DVR₁, DVR₂, and DVR₃, respectively. Of course, any number of DVRs can be incorporated. The DVR₀ comprises a master embedded web server 12 that controls the other DVRs which, in turn, each controls four camera sets 20, 21, 22, and 23, respectively, comprising 16 cameras in all, in this embodiment. Again, there is no limit on the possible number of cameras. The uniquely embedded master server 12 communicates with other servant servers that are not true web servers (e.g., traditional socket servers). These socket servers need not know about other servant servers in the system 10.

Sockets may also be used to communicate with the browser of the end user in the instance where a relatively static web page may not be sufficient (i.e., where the content of the web page changes only upon request by the user to reload the page).

The DVR₀ controls all of the DVRs by a peer interface module 14 that operatively connects to the other DVR peer interface modules 15, 16, and 17, respectively. The peer interface module 14 of the master device, DVR₀ has stored therein the network and addresses for each of the linked devices, DVR₁, DVR₂, DVR₃, etc. The DVR host software 19 provides internal control operations for each DVR. It does not connect to the other DVRs.

The user accesses the multiplicity of camera devices 20 through 23, respectively, using an ordinary web browser 18 from the web page 11. To the user, only this conventional web page is viewable. The web page contains data that is relevant to the multiplicity of devices. In the case of digital video recorders (DVRs), such data includes camera titles, quality levels, recent alarm events, diagnostics, etc. The user is aware that he can access or control the multiplicity of devices in groups 20 through 23, respectively, but he is not cognizant that these devices are located elsewhere and controlled by the other DVRs.

The master embedded web server 12 can be a digital video recorder (DVR) web server that accepts the Hypertext Transport Protocol (HTTP) request from the web browser 18. A DVR viewer control 24 can be loaded by the web browser 18 in order to display live or recorded video from the DVRs. The user clicks on the hyperlink of the web page to view the video from one of the cameras in the camera sets 20 through 23, respectively. The request is sent to the master web server 12 using an HTTP command 25. The master EWS 12 responds by sending a web page containing instructions for the browser 18 for receiving a video stream 26 for a desired camera, via the DVR viewer control 24. Additional DVRs can be added into the system 10 easily, by providing an administrative web page. The user informs the master DVR web server 12 of the address of a newly added DVR. This information is then incorporated into the master DVR web server 12.

As aforementioned, the DVR₀ web server 12 accepts the HTTP request from the web browser 18 on TCP/IP port 80. The web server 12 then delivers to the browser 18 a custom web page: a web page constructed by the web server. However, the DVR₀ web server 12 cannot do all of this alone. It must enlist the assistance of interface modules 15, 16, and 17, respectively, of the other DVRs.

The DVR viewer control 24 is a custom control that loads from the web browser 18, in order to display live or recorded video from the DVRs. To access this information, the user clicks on a hyperlink on the web page 11.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A peer distributed, embedded web server system for accessing and controlling a multiplicity of devices, comprising:
a master control device comprising an embedded web server, peer interface module, and host software;
a plurality of linked devices that communicate with, and that are controlled by, said embedded web server of said master control device, said plurality of linked devices each comprising an interface that communicates with the peer interface module of said master control device; and
means for providing a user operated web browser for communicating with said master control device in order to access said plurality of linked devices.

2. The peer distributed, embedded web server system for accessing and controlling a multiplicity of devices in accordance with claim 1, wherein said plurality of linked devices each comprises a peer interface module for communicating with the peer interface module of said master control device.

3. The peer distributed, embedded web server system for accessing and controlling a multiplicity of devices in accordance with claim 1, wherein said master control device and said plurality of linked devices each comprises a device from the group of digital video recorder, digital video encoder, and network camera.

4. The peer distributed, embedded web server system for accessing and controlling a multiplicity of devices in accordance with claim 3, wherein each digital video recorder is operatively connected to at least one camera.

5. The peer distributed, embedded web server system for accessing and controlling a multiplicity of devices in accordance with claim 1, wherein said master control device and said linked devices are each operatively connected to at least one camera.

6. The peer distributed, embedded web server system for accessing and controlling a multiplicity of devices in accordance with claim 5, wherein said web browser provides HTTP commands to said master control device for receiving a video stream from at least one of said predetermined EWS devices in said EWS system.

7. An embedded web server system for accessing and controlling a multiplicity of devices, comprising:
a master control device comprising an embedded web server, peer interface means, and host software;
a plurality of linked devices that communicate with, and that are controlled by, said embedded web server of said master control device, said plurality of linked devices each comprising an interface that communicates with the peer interface means of said master control device;
means for providing a user operated web browser for communicating with said master control device in order to access said plurality of linked devices; and
at least one camera operatively connected to said master control device, and at least one camera operatively connected to each of said plurality of linked devices.

8. The embedded web server system for accessing and controlling a multiplicity of devices in accordance with claim 7, wherein said plurality of linked devices each comprises peer interface means for communicating with the peer interface means of said master control device.

9. The embedded web server system for accessing and controlling a multiplicity of devices in accordance with claim 7, wherein said master control device and said plurality of linked devices each comprises a digital video recorder.

10. The embedded web server system for accessing and controlling a multiplicity of devices in accordance with claim 7, wherein said master control device and said linked devices are each operatively connected to at least one camera.

11. The embedded web server system for accessing and controlling a multiplicity of devices in accordance with claim 10, wherein said web browser provides HTTP commands to said master control device for receiving a video stream from at least one of said predetermined devices in said EWS system.
